(19) United States
(12) Patent Application Publication
(10) Pub. No.: US 2025/0378843 A1
(43) Pub. Date: Dec. 11, 2025

(54) ECHO CANCELLATION AND AUDIO PROCESSING FOR EMBEDDED SYSTEMS

(71) Applicant: Beken Corporation, Shanghai (CN)

(72) Inventors: Hangxun ZHOU, Shanghai (CN); Jianhua MENG, Shanghai (CN); Wei FENG, Shanghai (CN); Aixing LI, Shanghai (CN); Lulai CHEN, Shanghai (CN); Lianxue LIU, Shanghai (CN)

(73) Assignee: Beken Corporation, Shanghai (CN)

(21) Appl. No.: 18/904,906

(22) Filed: Oct. 2, 2024

(30) Foreign Application Priority Data
Jun. 7, 2024 (CN) 202410733049.1

(51) Int. Cl. G10L 21/0216; G10L 21/0208

(52) U.S. Cl. CPC G10L 21/0216; G10L 2021/02082; G10L 2021/02165

(57) ABSTRACT

The present disclosure addresses a system and a method for echo cancellation and signal processing. The method includes configuring an integrated signal processor on an embedded system, wherein the integrated signal processor includes at least an echo canceller and a noise suppressor. The method further includes receiving a reference sound signal transmitted from a client device and capturing, by a microphone of the embedded system, a microphone sound signal to be transmitted to the client device. The method further includes executing the echo canceller to generate a first output signal based on the reference sound signal, the microphone sound signal, and a preliminary echo cancelling coefficient and executing the noise suppressor to generate a second output signal based on the first output signal and a noise estimate. The method further includes transmitting the second output signal to the client device in replacement of the microphone sound signal.

### CROSS-REFERENCE TO RELATED APPLICATIONS

This application claims priority to and incorporates by reference Chinese application no. 202410733049.1 filed 7 Jun. 2024.

### TECHNICAL FIELD

The present disclosure generally relates to audio signal processing. In particular, examples of the present disclosure address systems and methods for effectively canceling echoes in audio communications of embedded systems.

### BACKGROUND

The integration of voice communication into mobile and Internet of Things (IoT) devices, including smart wearables and home automation systems, has become increasingly popular. These devices often rely on embedded systems with limited computational resources.

Echo cancellation is a crucial technology in the field of audio signal processing, particularly for voice communication. Echoes occur when sound emitted by a speaker is picked up by a microphone and retransmitted, leading to feedback loops and degraded audio quality. In complex systems with high processing capabilities, sophisticated echo cancellation algorithms and hardware can be employed to effectively mitigate these echoes. However, in embedded systems, such approaches are often impractical because the sophisticated echo cancellation algorithms and hardware typically require substantial computational resources and memory, which exceed the capacities of the embedded systems.

In addition to echo cancellation, audio processing systems are often required to perform subsequent tasks, such as noise suppression, filtering, equalization, etc., to enhance the overall sound quality. Traditionally, each of these tasks would require separate circuits and signal transformations, which significantly increase the computational load and memory requirements, making them difficult to be incorporated by the embedded systems.

Therefore, there is a need for echo cancellation and integrated audio processing solutions that accommodate the limited computational resources and memory of embedded systems.

### SUMMARY

In one aspect, a method at an embedded system for signal processing is provided. The method may include receiving a reference sound signal transmitted from a client device; capturing, by a microphone of the embedded system, a microphone sound signal to be transmitted to the client device; determining an energy ratio between the reference sound signal and the microphone sound signal; obtaining a preliminary echo cancelling coefficient; determining a preliminary output signal based on the reference sound signal, the microphone sound signal, and the preliminary echo cancelling coefficient; iteratively updating the preliminary output signal to generate a first output signal; generating a second output signal based on the first output signal and a noise estimate; and transmitting the second output signal to the client device in replacement of the microphone sound signal. The iterative updating of the preliminary output signal may include updating an updating index based on a predetermined step size, the reference sound signal, and an output signal determined in a preceding iteration; updating the preliminary echo cancelling coefficient based on the updated updating index, the energy ratio, and a predetermined suppression depth; and updating the preliminary output signal based on the reference sound signal, the microphone sound signal, and the updated preliminary echo cancelling coefficient.

In another aspect, an embedded system for signal processing is provided. The embedded system may include a processor and a memory. When executed by the processor, the memory may store instructions that configure the embedded system to receive a reference sound signal transmitted from a client device; capture, by a microphone of the embedded system, a microphone sound signal to be transmitted to the client device; generate a first output signal based on the reference sound signal, the microphone sound signal, and a preliminary echo cancelling coefficient; determine a noise estimate based on the first output signal and at least one predetermined smoothing factor; determine a filter coefficient based on the first output signal and the noise estimate; filter the first output signal based on the filter coefficient to generate a filtered first output signal; adjust the at least one predetermined smoothing factor based on the filtered first output signal; update the noise estimate based on the filtered first output signal and the adjusted at least one smoothing factor; update the filter coefficient based on the updated noise estimate and the filtered first output signal; filter the filtered first output signal based on the updated filter coefficient to generate a second output signal; and transmit the second output signal to the client device in replacement of the microphone sound signal.

In another aspect, a non-transitory computer-readable storage medium is provided. The computer-readable storage medium including instructions that when executed by an embedded system, cause the embedded system to receive a reference sound signal transmitted from a client device; capture, by a microphone of the embedded system, a microphone sound signal to be transmitted to the client device; generate a first output signal based on the reference sound signal, the microphone sound signal, and a preliminary echo cancelling coefficient; generate a second output signal based on the first output signal and a noise estimate; and transmit the second output signal to the client device in replacement of the microphone sound signal.

### BRIEF DESCRIPTION OF THE DRAWINGS

To easily identify the discussion of any particular element or act, the most significant digit or digits in a reference number refer to the figure number in which that element or act is first introduced.

FIG. 1 is a schematic diagram illustrating an audio transmission environment, in accordance with some example embodiments.

FIG. 2 is a block diagram of an embedded system, in accordance with some example embodiments.

FIG. 3 is a block diagram of an integrated signal processor, in accordance with some example embodiments.

FIG. 4 is a schematic diagram for processing sound signals using the integrated signal processor, in accordance with some example embodiments.

FIG. 5 is a schematic diagram for echo cancellation, in accordance with some example embodiments.

FIG. 6 is a schematic diagram for noise suppression, in accordance with some example embodiments.

FIG. 7 is a flowchart illustrating an exemplary process for processing sound signals, in accordance with some example embodiments.

FIG. 8 is a flowchart illustrating an exemplary process for echo cancellation, in accordance with some example embodiments.

FIG. 9 is a flowchart illustrating an exemplary process for noise suppression, in accordance with some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As mentioned above, there is a need for echo cancellation and audio processing solutions that accommodate the limited computational resources and memory of embedded systems.

The present disclosure provides systems and methods for echo cancellation that are primarily designed for embedded systems. It should be noted however that the methods and systems described herein are also applicable to other systems in which they can deliver competitive performance.

As a user speaks into the device, the microphone captures their voice along with any ambient sounds, which may include echoes from the device's speaker. The integrated signal processor of the present systems receives a reference sound signal from a remote client device and processes it alongside the microphone's sound signal. This enables the system to calculate energy ratios (also referred to as energy rates), adjust echo cancelling coefficients, and apply sound filtering techniques to produce an echo-reduced output signal.

In addition to echo cancellation, the integrated signal processor is employed to efficiently handle a variety of subsequent audio processing tasks. The tasks include noise reduction to eliminate background noise from the microphone signal, filtering low-frequency sounds, injecting comfort noise, equalization, and dynamic range control, etc. These tasks are managed by the integrated signal processor, which adjusts the parameters of each component based on specific user requirements or application needs. The parameters and algorithms of each signal processing component are fine-tuned to ensure the output is as refined as possible before it is transmitted back to the client device.

The present disclosure offers several advantages:

1. Low hardware requirement: The method is designed to reduce computational demands, which is beneficial for devices with limited processing capabilities and memory size, such as embedded systems.

2. Integration: A single integrated signal processor manages multiple audio-processing tasks, optimizing the use of memory and processing power.

3. Customizability and Controllability: The integrated signal processor provides individual control over each signal processing component, enabling customization of settings and parameters to meet diverse needs.

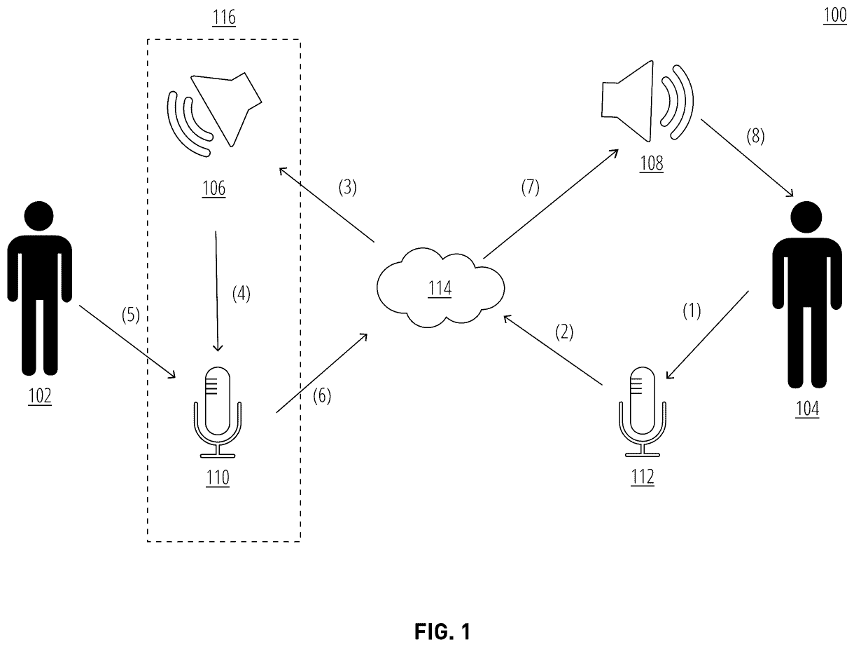

FIG. 1 is a block diagram illustrating an audio transmission environment 100, in accordance with some example embodiments. The audio transmission environment 100 is structured to enable voice communication between a first user (also referred to as near user) 102 and a second user (also referred to as remote user) 104. In some examples, a loudspeaker 106 and a microphone 110 are configured on the side of the first user 102 and a loudspeaker 108 and a microphone 112 are configured on the side of the second user 104. The loudspeaker 106 and the microphone 110 are components within an embedded system 116.

The loudspeakers 106 and 108 function as electric-to-acoustic transducers, converting electrical audio signals into sound waves. When an electrical signal is fed into the loudspeakers 106 and 108, the signal causes diaphragms of the loudspeakers 106 and 108 to vibrate, creating hearable sound waves. The microphones 110 and 112 function as acoustic-to-electric transducers, capturing sound waves from the environment and converting them into electrical audio signals. When a user speaks, the sound waves of the user cause the diaphragms of the microphones 110 and 112 to vibrate, which generates an electrical current that corresponds to the sound's frequency and amplitude. It should be noted that the term “audio signal” used in the present disclosure may refer to an electrical audio signal or a hearable audio signal, depending on the context.

The communication interface 114 acts as the central hub for data exchange within the audio transmission environment 100, facilitating the transfer of audio signals and control instructions between the first user 102 and the second user 104. The communication interface 114 may receive audio signals captured by the microphone 110 or the microphone 112 and relay the electrical audio signals to the loudspeaker 108 or the loudspeaker 106. The loudspeaker 108 or the loudspeaker 106 may then generate hearable audio signal based on received electrical audio signal. The communication interface 114 may also relay control instructions, such as, user settings, system configurations, etc., between the first user 102 and the second user 104 to optimize the signal transmission performance in the audio transmission environment 100. The communication interface 114 may include a wired communication and/or a wireless communication. In some examples, the communication interface may include standards, protocols, and technologies that define how data is formatted and transmitted. For example, the communication interface 114 may employ a Wi-Fi network under an IEEE 802.11 standard (e.g., 802.11, 802.11b, 802.11a, 802.11g, 802.11n, 802.11ac, 802.11ax, 802.11be, etc.). Alternatively, or additionally, the communication interface 114 may employ a Bluetooth, a ZigBee, a Z-Wave, a LPWAN, a RFID, a NFC, a serial interface, a parallel interface, an ethernet, a fiber optic, an HDMI, etc.

FIG. 1 also outlines the sequence of events that lead to echo formation in the audio transmission environment 100:

In step (1), the second user 104 speaks into the microphone 112.

In step (2), the microphone 112 captures the first user's voice as a first audio signal, converts it into a first electrical signal, and transmits it to the communication interface 114.

In step (3), the communication interface 114 relays the first electrical signal to the loudspeaker 106 of the embedded system 116.

In step (4), the loudspeaker 106 converts the first electrical signal back into an audible sound, known as the second audio signal, which can travel through the air and be picked up by the microphone 110.

In step (5), the first user 102 speaks into the microphone 110.

In step (6), the microphone 110 captures both the second audio signal from the loudspeaker 106 and a third audio signal of the first user 102's voice. The microphone 110 then converts the combined audio signal into a second electrical signal and transmits it to the communication interface 114.

In step (7), the communication interface 114 relays the second electrical signal to the loudspeaker 108.

In step (8), the loudspeaker 108 produces a fourth audio signal based on the second electrical signal. Since the fourth audio signal contains elements of the second user's original first audio signal, the second user 104 may experience an echo of their own voice.

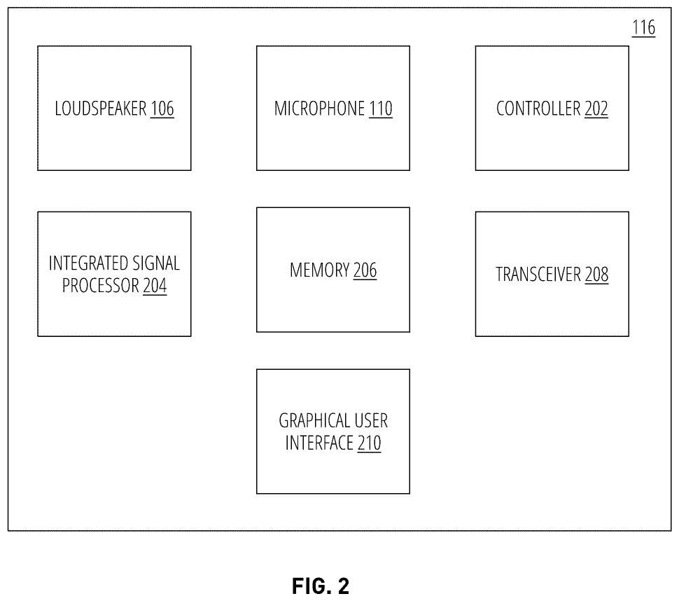

FIG. 2 is a block diagram of an embedded system 116, in accordance with some example embodiments. The embedded system 116 is designed to facilitate echo cancellation and audio processing for voice communication and may include a loudspeaker 106, a microphone 110, a controller 202, an integrated signal processor 204, a memory 206, a transceiver 208, and a graphical user interface 210. The configuration of the embedded system 116 is modular, allowing for additional components to be integrated as needed to enhance functionality or for existing components to be omitted or replaced depending on the specific application requirements.

The loudspeaker 106 and the microphone 110 has been described above and are not repeated herein.

The controller 202 acts as the central processing unit of the embedded system 116, coordinating the operations of all other components. The controller 202 may execute instructions stored in the memory 206 to control the signal processing tasks and manage data flow within the embedded system 116.

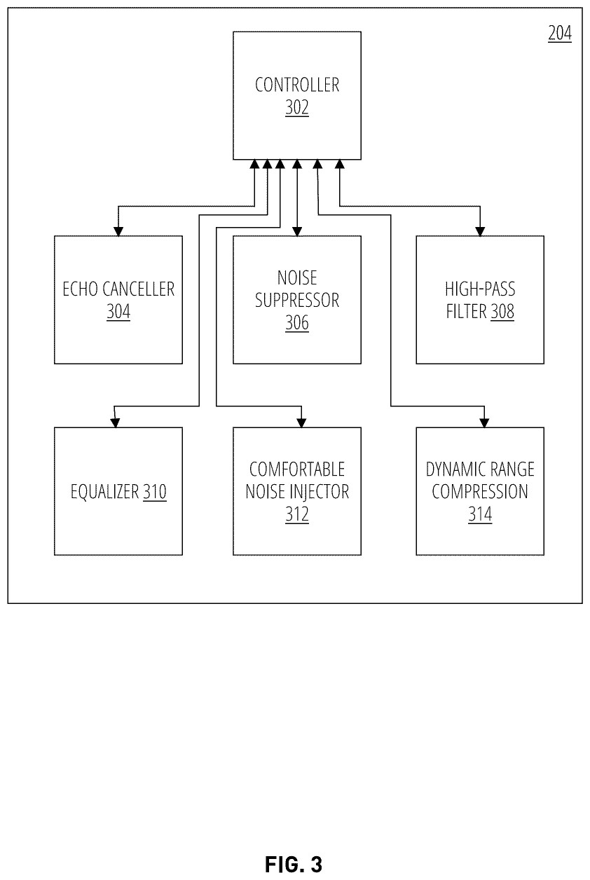

The integrated signal processor 204 is a specialized hardware component dedicated to processing audio signals. For example, the integrated signal processor 204 may perform a variety of functions, including echo cancellation, noise suppression, and possibly other audio processing tasks such as equalization, comfort noise injection, and dynamic range compression, as dictated by the embedded system 116's requirements. Details regarding the integrated signal processor 204 may be found elsewhere in the present disclosure, e.g., in FIG. 3 and descriptions thereof.

The memory 206 stores the operating system, application code, signal processing algorithms, machine models, and temporary data required for the operation of the embedded system 116. The memory 206 may include both non-volatile memory for long-term storage and volatile memory for quick access during operation.

The transceiver 208 facilitates wireless communication with external devices, such as client devices or other components of a communication network (e.g., the audio transmission environment 100). The transceiver 208 may support various communication protocols and standards to ensure compatibility and reliable data exchange.

The graphical user interface 210 provides a user-friendly means for users to interact with the embedded system 116. The graphical user interface 210 allows users to configure settings (e.g., echo cancellation or audio processing parameters), initiate or respond to voice communications, and receive visual feedback about the embedded system 116's status and ongoing processes (e.g., such as echo cancellation levels or noise suppression status). It should be noted that the graphical user interface 210 is merely an example of user interactive means. Other user interactive means, such as, microphone, keyboard, mouse, camera, joystick, etc., can be used in replacement of or in addition to the graphical user interface 210 and all such variations are within the protection scope of present disclosure.

FIG. 3 is a block diagram of an integrated signal processor 204, in accordance with some example embodiments. The integrated signal processor 204 is designed to enhance audio signal quality for voice communication and may include a controller 302 and one or more signal processing components, such as an echo canceller 304, a noise suppressor 306, a high-pass filter 308, an equalizer 310, a comfortable noise injector 312, a dynamic range compressor 314, etc. The configuration of the integrated signal processor 204 is modular, allowing for additional components to be integrated as needed to enhance functionality or for existing components to be omitted or replaced depending on the specific application requirements. Also, the term “integrated” merely indicates that the audio signal processing components can be combined into a single processor for potential benefits in size and computational efficiency. However, it is also within the scope of the present disclosure that the audio signal processing components are separately configured on the embedded system 116, e.g., each having their own controller, memory, signal transformer, etc., and being independent of each other.

The controller 302 serves as the central processing unit within the integrated signal processor 204, orchestrating the operations of the audio processing components in the integrated signal processor 204. The controller 302 may manage the flow of audio data through the signal processing pipeline in the integrated signal processor 204 and ensures that each component operates in synchronization to achieve optimal audio quality. The controller 302 is also responsible for adjusting the levels of echo cancellation, levels of noise suppression, and/or other audio processing parameters. The adjustment can be done either manually or automatically to suit different application scenarios.

For example, a control panel can be visually displayed on the graphical user interface 210, providing users with an interactive means to customize their audio experience. The controller 302 may also act as a switch for the algorithm modules, controlling the on and off states of the signal processing components within the integrated signal processor 204.

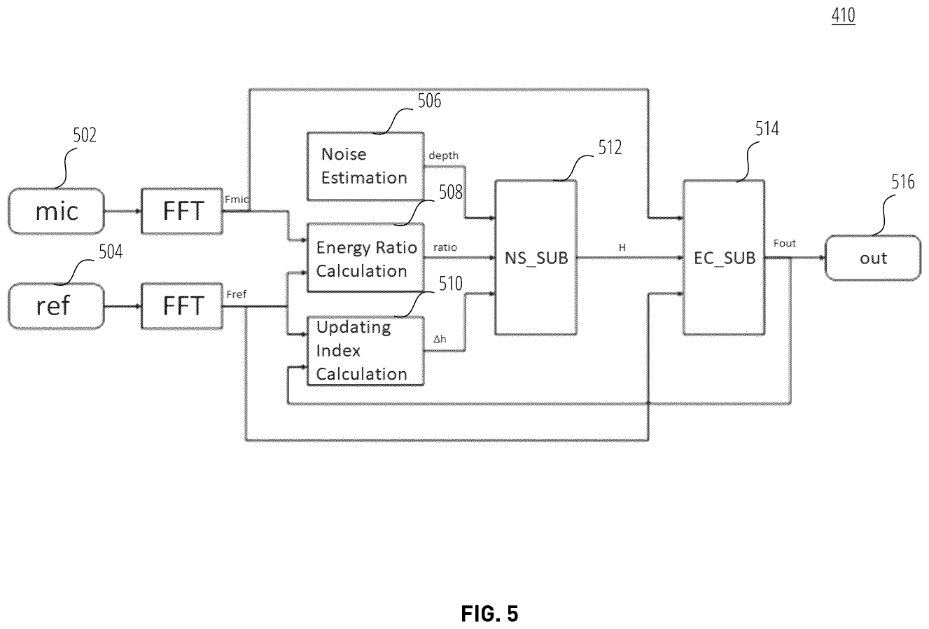

The echo canceller 304 identifies and mitigates echo within the audio signal to prevent feedback and reverberation that can degrade the quality of voice communication. The controller 302 may adjust the echo cancellation level as needed, based on user input or automatically according to predefined settings. Details regarding the echo canceller 304 may be found elsewhere in the present disclosure, e.g., in FIG. 5 and descriptions thereof.

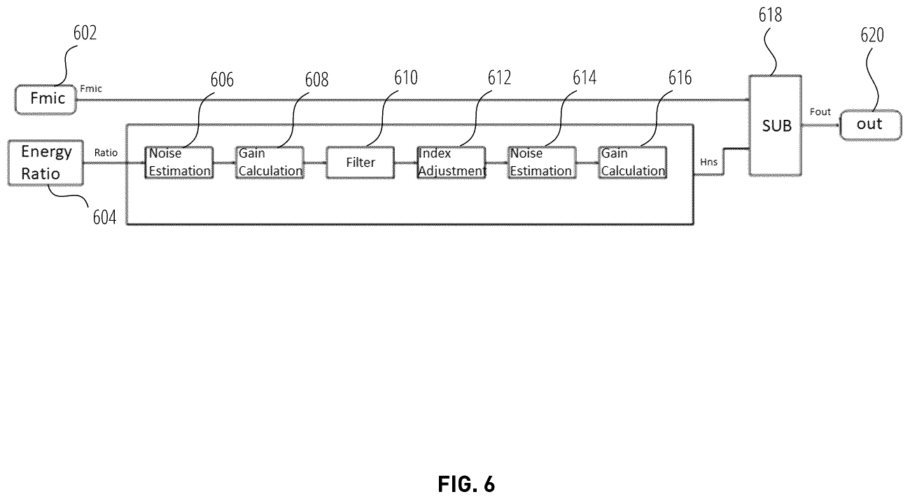

The noise suppressor 306 reduces background noise and enhances the signal-to-noise ratio, ensuring that the voice signal is clear and free from interference. The controller 302 may modify the noise suppression level to adapt to varying noise conditions, either through user interaction with the graphical user interface 210 or through automatic adjustments. Details regarding the noise suppressor 306 may be found elsewhere in the present disclosure, e.g., in FIG. 6 and descriptions thereof.

The high-pass filter 308 removes low-frequency noise and rumble from the audio signal, allowing only frequencies above a certain cutoff frequency to pass through, thereby improving the overall quality of the voice communication. The high-pass filter 308 zeroes the corresponding frequency points below the cutoff frequency and applies appropriate smoothing to the transition band around the cutoff frequency. The cutoff frequency point can be determined based on the specific requirements of the audio application, such as the desired voice frequency range or the environmental noise profile. Alternatively, the cutoff frequency point can be manually set by user interaction with the graphical user interface 210.

The equalizer 310 adjusts the frequency response of the audio signal across various bands, allowing for fine-tuning of the audio output to suit acoustic environments or user preferences, resulting in a more balanced and pleasant listening experience. For example, each frequency point is multiplied by a gain factor. The gain factors corresponding to different frequency points may be preset in the equalizer 310 for different acoustic environments. The controller 302 may automatically determine the acoustic environment and select the corresponding gain factor. Alternatively, a user may manually select the acoustic environment via the graphical user interface 210. The user can also directly set the gain factors via the graphical user interface 210. Merely by way of example, the frequency bands may include a sub-bass band at 20 to 80 Hz, a bass band at 80 to 250 Hz, a low midrange band at 250 to 500 Hz, a midrange band at 500 Hz to 1 kHz, an upper midrange band at 1 to 3 kHz, etc., however, these ranges of bands are not limiting.

The comfortable noise injector 312 introduces a level of background noise, known as comfort noise, into the audio signal. The noise injected can include a pink noise, or the like, with its amplitude decreasing as the frequency increases. In some examples, the noise is added in the frequency domain, ensuring that the noise is only added when the original signal amplitude is below a certain threshold, resulting in a more uniform spectrum after injection. The noise injection can also benefit subsequent wireless communication. Specifically, the presence of long sequences of zeros in a signal can be detrimental to wireless communication, as it may lead to a reduced error detection rate and overall inefficiency. This is because sequences of zeros do not provide sufficient variation in the signal for effective error detection algorithms to operate. Additionally, signals that have undergone high-pass filtering, such as those processed by the high-pass filter 308, may contain many zeros at lower frequencies due to the removal of low-frequency components. By injecting non-zero noise at these lower frequencies, the comfortable noise injector 312 can mitigate the issues associated with transmitting sequences of zeros. Consequently, comfortable noise injector 312 can facilitate a smoother and more reliable wireless communication.

The dynamic range compressor 314 dynamically adjusts the volume of the audio signal, compressing the dynamic range to maintain consistent audio levels. The dynamic range compressor 314 may calculate the gain coefficient for each frame dynamically, based on the maximum amplitude of the signal in the time domain of each frame, and apply different gains for different ranges. The gain coefficients for consecutive frames are moderately smoothed to help the transition from one frame to the next. The dynamic range compressor 314 can help prevent sudden peaks in volume that can be disruptive during voice communication.

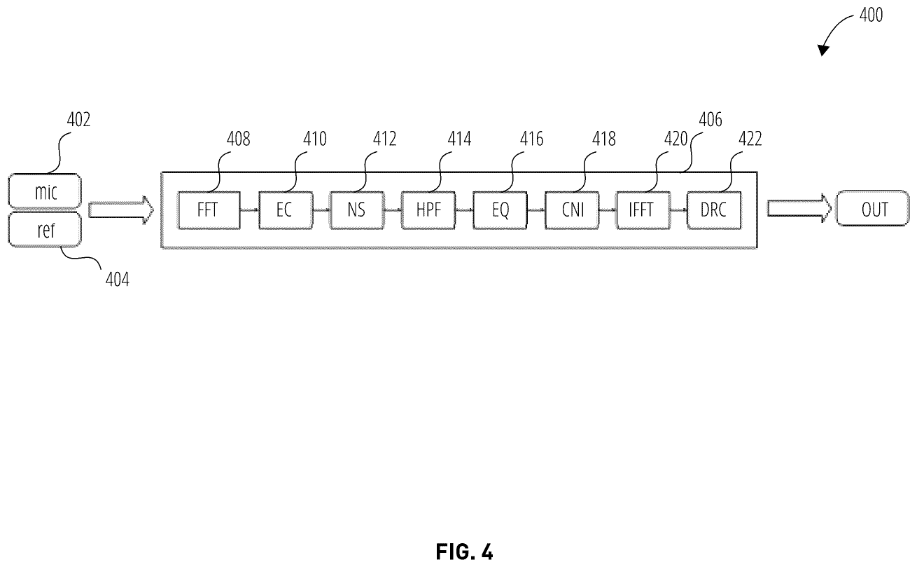

FIG. 4 is a schematic diagram 400 for processing sound signals using the integrated signal processor 204, in accordance with some example embodiments. Steps performed within box 406 are performed within the integrated signal processor 204.

The process in diagram 400 begins with the integrated signal processor 204 receiving a microphone sound signal 402 (mic) and an echo reference signal 404 (ref). The microphone sound signal 402 may be captured by the microphone 110 of the embedded system 116 and is to be transmitted to a client device (device of the second user 104). The echo reference signal 404 may be a voice signal received from the other end of an audio transmission environment (e.g., second user 104 of the audio transmission environment 100).

At step 408, a Fast Fourier Transform (FFT) is applied by a FFT transformer to both the microphone sound signal 402 and the echo reference signal 404, converting them from the time domain to the frequency domain for further processing.

At step 410, an echo canceller (EC) (e.g., echo canceller 304) processes the frequency domain signals to remove echo in the microphone sound signal 402, resulting in a microphone sound signal with reduced echo. The EC then forwards the echo-reduced microphone sound signal to a noise suppression (NS) (e.g., noise suppressor 306).

At step 412, the NS performs noise reduction on the echo-reduced microphone signal, filters out background noise to produce a cleaner microphone signal and then sends it to a high-pass filter (HPF) (e.g., high-pass filter 308).

At step 414, the HPF processes the received signal to remove low-frequency noise, allowing only higher frequencies to pass through. The filtered signal is then directed to an equalizer (EQ) (e.g., equalizer 310).

At step 416, the EQ adjusts the balance of frequencies in the signal to enhance audio quality. The signal is then forwarded to the comfortable noise injector (CNI) (e.g., comfortable noise injector 312).

At Step 418, the CNI adds comfort noise to the received signal, which helps to create a more natural and comfortable listening experience. The processed signal is then forwarded to an inverse FFT (IFFT) transformer.

At step 420, the IFFT transformer converts the received frequency domain signal back to the time domain, preparing it for a dynamic range compressor (DRC) (e.g., dynamic range compressor 314).

At step 422, the DRC adjusts the audio gain to maintain consistent audio levels and outputs the processed time domain microphone signal. The output signal may be transmitted to a client device in replacement of the original microphone sound signal 402.

It should be understood that the steps outlined in the schematic diagram 400 for processing sound signals are presented in a sequential manner for illustrative purposes only. Instead, the order of the steps may be altered, additional steps may be included, and existing steps may be replaced or omitted. Such variations are all within the protection scope of the present disclosure. Furthermore, certain steps may be performed in parallel rather than sequentially, leveraging parallel processing capabilities to enhance efficiency and reduce processing time.

FIG. 5 is a schematic diagram for echo cancellation (e.g., step 410) performed at the echo canceller 304, in accordance with some example embodiments. FIG. 5 details the internal workings of the echo canceller 304 in the process of removing unwanted echo from a microphone sound signal during audio processing. The echo canceller 304 may include FFT, filter coefficient calculation and echo cancellation subcomponent 514. The filter coefficient calculation may include noise estimation 506, energy ratio calculation 508, updating index calculation 510, and noise suppression subcomponent 512.

The echo cancellation process begins with the echo canceller 304 receiving a microphone sound signal 502 (mic) and a reference sound signal 504 (ref). The microphone sound signal 502 represents the audio captured by the microphone that includes both the desired speech and any echo caused by a loudspeaker near the microphone. The reference sound signal 504 represents the audio signal that cause echo, such as a signal captured by a microphone of a remote client device. In some examples, the integrated signal processor 204 has a pre-determined size of buffer. A delay time between the reference sound 504 and the microphone sound signal 502 may be determined based on the size of data buffered in the integrated signal processor. The reference sound signal 504 can be shifted by the delay time to be aligned with the microphone sound signal 502.

FFT may include applying a Fourier transformation separately to the microphone sound signal 502 and the reference sound signal 504 (ref) to convert each sound signal from the time domain to the frequency domain. Such transformation may facilitate subsequent algorithmic processing. The transformed microphone signal 502 is denoted by the Fmic, and the transformed reference signal 504 is denoted by the Fref.

Energy ratio calculation 510 may include calculating the ratio of energy (also referred to as energy ratio or energy rate) between the transformed microphone signal Fmic and the transformed reference signal Fref within a frequency band. The calculation formula is as follows:

$$ratio = Fmic / Fref \qquad ( 1 )$$

The frequency band may be determined as a range of frequency. In some examples, multiple frequency bands may be determined, and multiple energy ratios are calculated. Merely by way of example, the frequency bands may include a sub-bass band at 20 to 80 Hz, a bass band at 80 to 250 Hz, a low midrange band at 250 to 500 Hz, a midrange band at 500 Hz to 1 kHz, an upper midrange band at 1 to 3 kHz, etc., however, these ranges of bands are not limiting.

The echo estimation 506 may include estimating a suppression depth of the echo, denoted by depth, which affects the aggressiveness of echo removal. The suppression depth of the echo may be preset by the integrated signal processor 204 or by a user via the graphical user interface 210. The suppression depth of the echo can also be dynamically determined based on the environment condition. Example values for suppression depth might include 30%, 50%, 70%, 100%, 200%, 300%, etc.

The updating index calculation 510 may include calculating an updating index, denoted by Δh. The calculation formula is as follows:

$$Δ h = Δ h + mu ( Fout / Fref ) \qquad ( 2 )$$

where mu denotes an updating step size, Δh denotes the updating index, and Fout denotes output signal. The step size can be expressed in linear terms or as a logarithmic measure, such as decibels, depending on the system's processing approach. In some examples, the step size can be 1 decibel, 2 decibels, 5 decibels, 10 decibels, etc.

The noise suppression subcomponent 512 may calculate a filter coefficient H, based on the following formula:

$$H = Δ h * ratio * depth \qquad ( 3 )$$

The echo cancellation subcomponent 514 may calculate an output signal Fout (echo-reduced or echo-cancelled signal), based on the following formula:

$$Fout = Fmic - H * Fref \qquad ( 4 )$$

In some examples, the output signal Fout should converge to a local minimum value through an optimization process that seeks to minimize echo while preserving the desired signal, with a corresponding target filter coefficient H. If the filter coefficient H is lower than the target value, the output signal Fout may have residual echos. If the filter coefficient H is higher than the target value, part of the wanted microphone signal Fmic may be comingled with the H*Fref and canceled, causing the output signal Fout to be higher than convergence and contain incomplete speech of the user near the microphone. In scenarios when the user near the microphone is not talking, while the user of remote client device talks and creates echoes, the output signal Fout shall ideally converge to zero.

In brevity, the echo canceller 304 iteratively updates the updating index Δh, the filter coefficient H, and the output signal Fout, until Fout reaches a local minimum value (convergence). Then the echo canceller 304 outputs the final output signal 516 to other audio processing components for subsequent audio processes.

In some examples, the energy ratio (or energy rate) between the transformed microphone signal Fmic and the transformed reference signal Fref may be very different when only the remote user is talking (single talk) or when both the near user and the remote user are talking at the same time (double talk). The echo canceller 304 may determine that only the remote user is talking based on conditions that the transformed reference sound signal Fref is greater than an echo threshold ec_thr and the ratio between Fmic and Fref is less than a ratio threshold RxRxThr. The former condition indicates that the remote user is talking (an echo is present) while the later condition indicates that the near user is not talking. In some examples, the echo threshold ec_thr can be 0.25, 0.5, 1, etc. times a reference microphone amplitude based on microphone configurations. The ratio threshold RxRxThr can be 1, 1.5, 2, 2.5, 3, etc.

When only the remote user is talking, the updating index may be increased or decreased based on the Fout/Fref, thereby maximally canceling the echoes. In some examples, the iterative updating of the updating index Δh, the filter coefficient H, and the output signal Fout may be more frequent when only the remote user is talking and less frequent when both the remote user and the near user are talking. The frequency of the update can also be adjusted dynamically.

FIG. 6 is a schematic diagram for noise suppression (e.g., step 412) performed at the noise suppressor 306, in accordance with some example embodiments. FIG. 6 illustrates the process flow within the noise suppressor 306, which is responsible for reducing unwanted noise from a microphone sound signal (or an echo-cancelled microphone sound signal).

The noise suppressor 306 utilizes a filter (e.g., a Wiener filter, a Kalman filter, a spectral subtraction filter, a least mean squares filter, a recursive least square filter, a Perona-Malik Filter, etc.) for noise reduction. The calculation of the filter gain coefficient is guided by a decision-based method and involves two times of filtering. The result of the first filtering with fixed parameters serves as a reference for voice activity detection (VAD) across different frequency bands. Based on this, noise estimation is updated, and the gain coefficient is recalculated for each frequency band before the signal is filtered a second time.

The noise suppression may include two parts: noise suppression filter coefficient calculation and filter subcomponent 618. The noise suppression filter coefficient calculation may include a first noise estimation 606, a first gain calculation 608, a filter 610, an index adjustment 612, a second noise estimation 614, and a second gain calculation 616. The noise suppression filter takes the energy ratio 604 as input and generates a gain (or frequency response, spectrum estimation) of the filter as an output. The filter subcomponent 618 may generate an output signal 620 based on echo-cancelled microphone signal 602 and the gain of the filter calculated in the second gain calculation 616.

A speech model that contains noise is as follows:

$$y ( n ) = s ( n ) + d ( n ) \qquad ( 5 )$$

where s(n) denotes speech signal, d(n) denotes noise, and y(n) denotes microphone signal. The signals in frequency domain can be expressed as Y(k), S(k), and D(k), respectively. Taking wiener filter as an example, the frequency domain spectrum estimation (also referred to as gain and phase shift at each frequency) for the Wiener filter is as follows:

$$H ( k ) = \frac{{P}_{S} [ k ]}{{P}_{s} [ k ] + {P}_{d} [ k ]} \qquad ( 6 )$$

where H(k) denotes the spectrum estimation of the Wiener filter, P_{S}[k] denotes the power spectrum of the speech signal S(k), P_{d}[k] denotes the power spectrum of the noise signal D(k). The power spectrum is a way to represent the signal in the frequency domain, showing how the energy of the signal is distributed with frequency. The frequency domain spectrum estimation H(k) is the filter's frequency response, which is used to estimate how much of each frequency component of the input signal should be retained (speech) or suppressed (noise) to minimize the overall mean square error between the filtered signal and the original clean speech signal.

A priori signal-to-noise ratio (or prior SNR) SNRₚᵣᵢₒᵣ[k] may be defined as:

$${SNR}_{prior} [ k ] = \frac{{P}_{S} [ k ]}{{P}_{d} [ k ]} \qquad ( 7 )$$

Then, the frequency domain spectrum estimation of the Wiener filter can be expressed as:

$$H ( k ) = \frac{{SNR}_{prior} [ k ]}{1 + {SNR}_{prior} [ k ]} \qquad ( 8 )$$

A posterior SNR (or post SNR) SNRₚₒₛₜ[k] may be defined as:

$${SNR}_{post} [ k ] = \frac{{P}_{y} [ k ]}{{P}_{d} [ k ]} \qquad ( 9 )$$

Since P_{y}[k]=Pₛ[k]+P_{d}[k] (derived from formula 5 and based on definition), a relationship between prior SNR and post SNR may be expressed as:

$${SNR}_{prior} [ k ] = {SNR}_{post} [ k ] - 1 \qquad ( 10 )$$

After introducing a smoothing factor α, the prior SNR SNRₚᵣᵢₒᵣ[k] can be expressed as:

$$( 11 )$$

$$\begin{matrix}{SNR}_{prior} [ k ] = α {{SNR}_{prior} [ k ]}_{t} + ( 1 - α ) {{SNR}_{prior} [ k ]}_{t} \\ = α {{SNR}_{prior} [ k ]}_{t} + ( 1 - α ) ( {{SNR}_{post} [ k ]}_{t} - 1 ) \\ \approx α {{SNR}_{prior} [ k ]}_{( t - 1 )} + ( 1 - α ) ( {{SNR}_{post} [ k ]}_{t} - 1 ) \\ = {α ( {H ( k )}_{( t - 1 )} {Y [ k ]}_{( t - 1 )} )}^{2} / {( {D ( k )}_{( t - 1 )} )}^{2} + ( 1 - α ) ( {{SNR}_{post} [ k ]}_{t} - 1 ) \\ = α {H ( k )}_{( t - 1 )}^{2} {{SNR}_{post} [ k ]}_{( t - 1 )} + ( 1 - α ) ( {{SNR}_{post} [ k ]}_{t} - 1 )\end{matrix}$$

In this way, the spectrum estimation of Wiener filter of a current frame (which is a function of prior SNR of a current frame based on formula (8)) can be recursively determined based on the previous frame's post SNR and spectrum estimation and current frame's post SNR.

The post SNR may be expressed as:

$${SNR}_{post} [ k ] = \frac{{{P}_{y} [ k ]}_{t}}{{{P}_{d} [ k ]}_{t}} \qquad ( 12 )$$

In some examples, P_{y}[k]ₜ can be directly calculated based on captured signal while P_{d}[k]ₜ cannot be obtained directly and a noise estimation is performed. It should be noted different types of noise estimation methods may be employed and the method describes below shall not be limiting.

For example, the noise can be estimated based on the following formula, which combines a spectral short-time minimum method and time recursive averaging method:

$${D [ k ]}_{t} = \{ \begin{matrix}{SM}_{1} {D [ k ]}_{t - 1} + ( 1 - {SM}_{1} ) {S [ k ]}_{t} , & {D [ k ]}_{t - 1} > {S [ k ]}_{t} \\ max ( {D [ k ]}_{t - 1} , {SM}_{2} {D [ k ]}_{t - 1} + ( 1 - {SM}_{2} ) \frac{{S [ k ]}_{t} - {SM}_{3} {S [ k ]}_{t - 1}}{( 1 - {SM}_{3} )} ) , & {D [ k ]}_{t - 1} \leq {S [ k ]}_{t}\end{matrix} \qquad ( 13 )$$

where D[k]ₜ₋₁ denotes a noise estimation of the k^{th} frequency point at T=t−1, SM₁, SM₂, SM₃∈(0,1) are smoothing factors. A smaller SM₁ means a higher noise estimation decay rate, which leads to less noise estimation and suppression. Conversely, a larger SM₁ results in a lower noise estimation decay rate, causing more noise estimation and suppression. A smaller SM₂ value indicates a higher noise estimation update rate, which leads to more noise estimation and suppression. Conversely, a larger SM₂ value means a lower noise estimation update rate, resulting in less noise estimation and suppression. A smaller SM₃ value corresponds to a lower frame difference update rate, which leads to less noise estimation and suppression. In contrast, a larger SM₃ value means a higher frame difference update rate, resulting in more noise estimation and suppression.

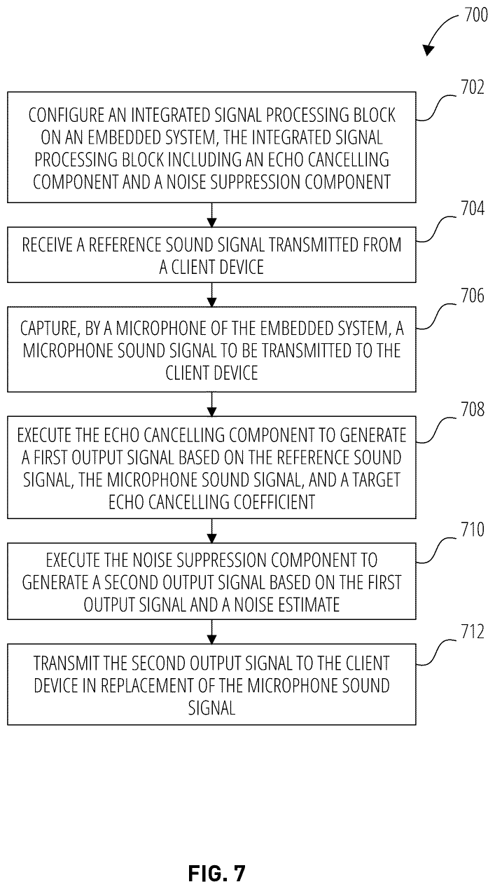

FIG. 7 is a flowchart illustrating an exemplary method 700 for processing sound signals, in accordance with some example embodiments. The method 700 may be embodied in computer-readable instructions for execution by one or more processors such that operations of the method 700 may be performed in part or in whole by the functional components of the embedded system 116; accordingly, the method 700 is described below by way of example with reference thereto. However, it shall be appreciated that at least some of the operations of the method 700 may be deployed on various other hardware configurations than the embedded system 116. Also, the operations of the method 700 may be partially omitted, or performed in any order.

In operation 702, an integrated signal processing block (or integrated signal processor) may be configured on the embedded system 116. The integrated signal processing block may include an echo cancelling component (or echo canceller) and a noise suppression component (or noise suppressor).

In operation 704, the embedded system 116 may receive a reference sound signal transmitted from a client device. This reference sound signal serves as a benchmark for the echo canceller to identify and mitigate echo in the sound captured by the microphone.

In operation 706, the embedded system 116 may capture, by a microphone of the embedded system 116, a microphone sound signal to be transmitted to the client device. This microphone sound signal includes the user's voice and any ambient sounds, including potentially the reference sound signal which is played out by a nearby loudspeaker.

In operation 708, the embedded system 116 may execute an echo cancelling component to generate a first output signal based on the reference sound signal, the microphone sound signal, and a target echo cancelling coefficient.

In operation 710, the embedded system 116 may execute a noise suppression component to generate a second output signal based on the first output signal and a noise estimate.

In operation 712, the embedded system 116 may transmit the second output signal to the client device in replacement of the microphone sound signal.

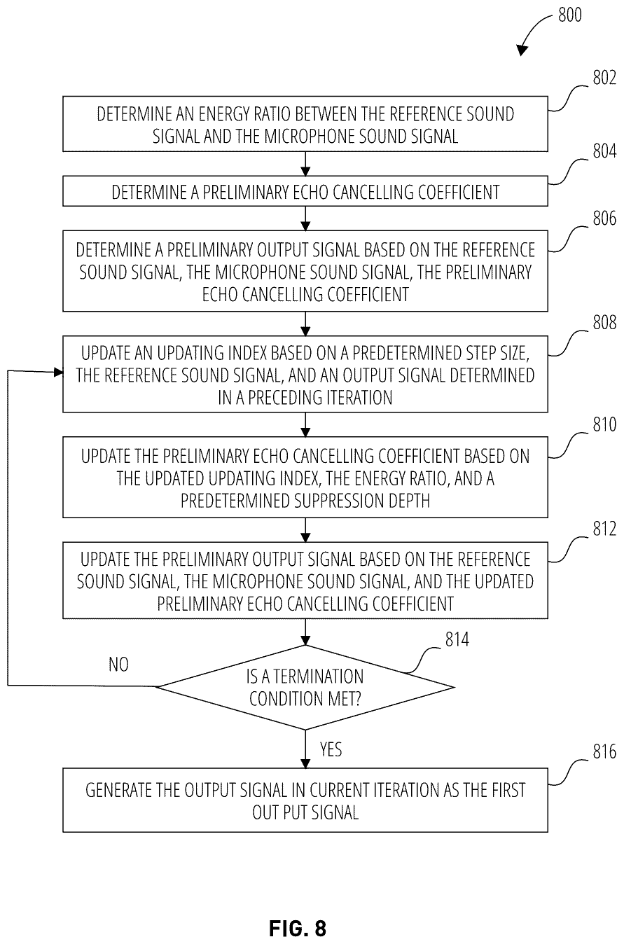

FIG. 8 is a flowchart illustrating an exemplary method 800 for echo cancellation, in accordance with some example embodiments. The method 800 may be embodied in computer-readable instructions for execution by one or more processors such that operations of the method 800 may be performed in part or in whole by the functional components of the embedded system 116; accordingly, the method 800 is described below by way of example with reference thereto. However, it shall be appreciated that at least some of the operations of the method 800 may be deployed on various other hardware configurations than the embedded system 116. Also, the operations of the method 800 may be partially omitted or performed in any order. Method 800 may correspond to operation 708.

In operation 802, the embedded system 116 may determine an energy ratio between the reference sound signal and the microphone sound signal. The energy ratio may be determined based on formula (1).

In operation 804, the embedded system 116 may determine a preliminary echo cancelling coefficient (also referred to as filter coefficient). The preliminary echo cancelling coefficient may be preset.

In operation 806, the embedded system 116 may determine a preliminary output signal based on the reference sound signal, the microphone sound signal, and the preliminary echo cancelling coefficient. The preliminary output signal may be determined based on formula (4).

In operation 808, the embedded system 116 may update an updating index based on a predetermined step size, the reference sound signal, and an output signal determined in a preceding iteration. The updating index may be updated based on formula (2).

In operation 810, the embedded system 116 may update the preliminary echo cancelling coefficient based on the updated updating index, the energy ratio, and a predetermined suppression depth. The preliminary echo cancelling coefficient may be updated based on formula (3).

In operation 812, the embedded system 116 may update the preliminary output signal based on the reference sound signal, the microphone sound signal, and the updated preliminary echo cancelling coefficient. The preliminary output signal may be updated or regenerated based on formula (4).

In operation 814, the embedded system 116 may determine whether a termination condition is met. In response to determining that the termination condition is met, the method 800 proceeds to operation 816; otherwise, the method 800 proceeds back to operation 808. The termination condition may include but is not limited to one or more of the following criteria: a preset count of iterations being reached, a determination that the energy ratio has stabilized within a predefined threshold, a determination that the output signal has reached a local minimum, a determination that the change in the echo cancelling coefficient between iterations falls below a certain threshold value, etc.

In operation 816, the embedded system 116 may generate the output signal in the current iteration as the target output signal (or referred to as first output signal in operation 708).

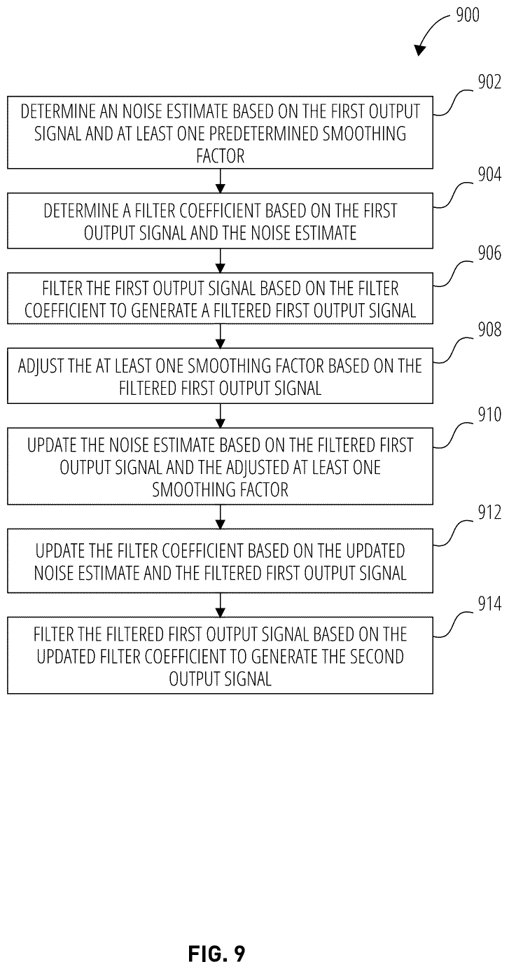

FIG. 9 is a flowchart illustrating an exemplary method 900 for noise suppression, in accordance with some example embodiments. The method 900 may be embodied in computer-readable instructions for execution by one or more processors such that operations of the method 900 may be performed in part or in whole by the functional components of the embedded system 116; accordingly, the method 900 is described below by way of example with reference thereto. However, it shall be appreciated that at least some of the operations of the method 900 may be deployed on various other hardware configurations than the embedded system 116. Also, the operations of the method 900 may be partially omitted or performed in any order. Method 900 may correspond to operation 710.

In operation 902, the embedded system 116 may determine a noise estimate based on the first output signal (e.g., output signal generated in operation 816 or operation 708) and at least one predetermined smoothing factor. The noise estimate may be determined based on formula (13).

In operation 904, the embedded system 116 may determine a filter coefficient based on the first output signal and the noise estimate. The filter coefficient may be determined based on formula (11).

In operation 906, the embedded system 116 may filter the first output signal based on the filter coefficient to generate a filtered first output signal.

In operation 908, the embedded system 116 may adjust the at least one smoothing factor based on the filtered first output signal.

In operation 910, the embedded system 116 may update the noise estimate based on the filtered first output signal and the adjusted at least one smoothing factor. The noise estimate may be updated based on formula (13).

In operation 912, the embedded system 116 may update the filter coefficient based on the updated noise estimate and the filtered first output signal. The filter coefficient may be updated based on formula (11).

In operation 914, the embedded system 116 may filter the filtered first output signal based on the updated filter coefficient to generate the second output signal.

### EXAMPLES

1. A method at an embedded system for signal processing, the method comprising:
   receiving a reference sound signal transmitted from a client device;
   capturing, by a microphone of the embedded system, a microphone sound signal to be transmitted to the client device;
   determining an energy ratio between the reference sound signal and the microphone sound signal;
   obtaining a preliminary echo cancelling coefficient;
   determining a preliminary output signal based on the reference sound signal, the microphone sound signal, and the preliminary echo cancelling coefficient;
   iteratively updating the preliminary output signal to generate a first output signal, the iterative updating of the preliminary output signal including:
      updating an updating index based on a predetermined step size, the reference sound signal, and an output signal determined in a preceding iteration;
      updating the preliminary echo cancelling coefficient based on the updated updating index, the energy ratio, and a predetermined suppression depth; and
      updating the preliminary output signal based on the reference sound signal,
the microphone sound signal, and the updated preliminary echo cancelling coefficient;
generating a second output signal based on the first output signal and a noise estimate; and
transmitting the second output signal to the client device in replacement of the microphone sound signal.
2. The method of example 1, further comprising:
   determining that the energy ratio between the microphone sound signal and the reference sound signal is less than a ratio threshold and the reference sound signal is greater than an echo threshold; and
   increasing a frequency of the iteratively updating of the preliminary output signal.
3. The method of any of examples 1-2, further comprising:
   determining that the energy ratio between the microphone sound signal and the reference sound signal is less than a ratio threshold and the reference sound signal is greater than an echo threshold;
   comparing the output signal determined in the preceding iteration with a threshold;
   in response to a comparison result that the output signal determined in the preceding iteration is greater than the threshold, increasing the updating index based on the predetermined step size; and
   in response to a comparison result that the output signal determined in the preceding iteration is less than the threshold, decreasing the updating index based on the predetermined step size.
4. The method of any of examples 1-3, wherein the generating of the second output signal based on the first output signal and the noise estimate comprises:
   determining the noise estimate based on the first output signal and at least one predetermined smoothing factor;
   determining a filter coefficient based on the first output signal and the noise estimate;
   filtering the first output signal based on the filter coefficient to generate a filtered first output signal;
   adjusting the at least one predetermined smoothing factor based on the filtered first output signal;
   updating the noise estimate based on the filtered first output signal and the adjusted at least one smoothing factor;
   updating the filter coefficient based on the updated noise estimate and the filtered first output signal; and
   filtering the filtered first output signal based on the updated filter coefficient to generate the second output signal.
5. The method of any of examples 1-4, further comprising:
   attenuating frequency bands of second output signal below a cut-off frequency to generate a third output signal.
6. The method of any of examples 1-5, further comprising:
   adjusting a plurality of frequency bands in the second output signal based on a plurality of parameters across the plurality of frequency bands to generate a third output signal.
7. The method of any of examples 1-6, further comprising:
   injecting a noise signal to the second output signal to generate a third output signal.
8. The method of example 7, wherein the noise signal is a pink noise that decreases in amplitude as frequency increases.
9. The method of any of examples 1-8, further comprising:
   dynamically calculating a gain coefficient for each frame of the second output signal based on a maximum amplitude within the frame; and
   apply the gain coefficient on the each frame of the second output signal to generate a third output signal.
10. The method of any of examples 1-9, further comprising:
   providing a graphical user interface;
   receiving user configurations via the graphical user interface; and
   adjusting parameters of the embedded system based on the user configurations.
11. The method of any of examples 1-10, further comprising:
   determining a size of data buffered in the embedded system;
   estimating a delay time based on the size of data buffered in the embedded system; and
   shifting the reference sound signal by the delay time to align the reference sound signal with the microphone sound signal.
12. An embedded system for signal processing, the embedded system comprising:
   a processor; and
   a memory storing instructions that, when executed by the processor, configure the embedded system to:
      receive a reference sound signal transmitted from a client device;
      capture, by a microphone of the embedded system, a microphone sound signal to be transmitted to the client device;
      generate a first output signal based on the reference sound signal, the microphone sound signal, and a preliminary echo cancelling coefficient;
      determine a noise estimate based on the first output signal and at least one predetermined smoothing factor;
      determine a filter coefficient based on the first output signal and the noise estimate;
      filter the first output signal based on the filter coefficient to generate a filtered first output signal;
      adjust the at least one predetermined smoothing factor based on the filtered first output signal;
      update the noise estimate based on the filtered first output signal and the adjusted at least one smoothing factor;
      update the filter coefficient based on the updated noise estimate and the filtered first output signal;
      filter the filtered first output signal based on the updated filter coefficient to generate a second output signal; and
      transmit the second output signal to the client device in replacement of the microphone sound signal.
13. The embedded system of example 12, wherein to generate the first output signal based on the reference sound signal, the microphone sound signal, and the preliminary echo cancelling coefficient, the instructions configure the embedded system to:
   determine an energy ratio between the reference sound signal and the microphone sound signal;
   obtain the preliminary echo cancelling coefficient;
   determine a preliminary output signal based on the reference sound signal, the microphone sound signal, the preliminary echo cancelling coefficient; and
   iteratively update the preliminary output signal to generate the first output signal, the iterative updating of the preliminary output signal including:
      update an updating index based on a predetermined step size, the reference sound signal, and an output signal determined in a preceding iteration;
      update the preliminary echo cancelling coefficient based on the updated updating index, the energy ratio, and a predetermined suppression depth; and
      update the preliminary output signal based on the reference sound signal, the microphone sound signal, and the updated preliminary echo cancelling coefficient.
14. The embedded system of example 13, wherein the instructions further configure the embedded system to:
   determine that the energy ratio between the microphone sound signal and the reference sound signal is less than a ratio threshold and the reference sound signal is greater than an echo threshold; and
   increase a frequency of the iteratively updating of the preliminary output signal.
15. The embedded system of any of examples 13 or 14, wherein the instructions further configure the embedded system to:
   determine that the energy ratio between the microphone sound signal and the reference sound signal is less than a ratio threshold and the reference sound signal is greater than an echo threshold;
   compare the output signal determined in the preceding iteration with a threshold;
   in response to a comparison result that the output signal determined in the preceding iteration is greater than the threshold, increase the updating index based on the predetermined step size; and
   in response to a comparison result that the output signal determined in the preceding iteration is less than the threshold, decrease the updating index based on the predetermined step size.
16. The embedded system of any of examples 12-15, wherein the instructions further configure the embedded system to:
   inject a noise signal to the second output signal to generate a third output signal.
17. The embedded system of any of examples 12-16, wherein the instructions further configure the embedded system to:
   dynamically calculate a gain coefficient for each frame of the second output signal based on a maximum amplitude within the frame; and
   apply the gain coefficient on the each frame of the second output signal to generate a third output signal.
18. The embedded system of any of examples 12-17, wherein the instructions further configure the embedded system to:
   provide a graphical user interface;
   receive user configurations via the graphical user interface; and
   adjust parameters of the embedded system based on the user configurations.
19. The embedded system of any of examples 12-18, wherein the instructions further configure the embedded system to:
   determine a size of data buffered in the embedded system;
   estimate a delay time based on the size of data buffered in the embedded system; and
   shift the reference sound signal by the delay time to align the reference sound signal with the microphone sound signal.
20. A non-transitory computer-readable storage medium, the computer-readable storage medium including instructions for signal processing that when executed by an embedded system, cause the embedded system to:
   receive a reference sound signal transmitted from a client device;
   capture, by a microphone of the embedded system, a microphone sound signal to be transmitted to the client device;
   generate a first output signal based on the reference sound signal, the microphone sound signal, and a preliminary echo cancelling coefficient;
   generate a second output signal based on the first output signal and a noise estimate; and
   transmit the second output signal to the client device in replacement of the microphone sound signal.

### CONCLUSION

The present disclosure provides system and methods for echo cancellation and audio processing. As a user speaks into the device, the microphone captures their voice along with any ambient sounds, which may include echoes from the device's speaker. The integrated signal processor of the present systems receives a reference sound signal from a remote client device and processes it alongside the microphone's sound signal. This enables the system to calculate energy ratios (also referred to as energy rates), adjust echo cancelling coefficients, and apply sound filtering techniques to produce an echo-reduced output signal. In addition to echo cancellation, the integrated signal processor is employed to efficiently handle a variety of subsequent audio processing tasks. The tasks include noise reduction to eliminate background noise from the microphone signal, filtering low-frequency sounds, injecting comfort noise, equalization, and dynamic range control, etc. These tasks are managed by the integrated signal processor, which adjusts the parameters of each component based on specific user requirements or application needs. The parameters and algorithms of each signal processing component are fine-tuned to ensure the output is as refined as possible before it is transmitted back to the client device.

The present disclosure potentially has at least the following advantages: 1. Low hardware requirement: The method is designed to reduce computational demands, which is beneficial for devices with limited processing capabilities and memory size, such as embedded systems. 2. Integration: A single integrated signal processor manages multiple audio-processing tasks, optimizing the use of memory and processing power. 3. Customizability and Controllability: The integrated signal processor provides individual control over each signal processing component, enabling customization of settings and parameters to meet diverse needs.

What is claimed is:

1. A method at an embedded system for signal processing, the method comprising:
receiving a reference sound signal transmitted from a client device;
capturing, by a microphone of the embedded system, a microphone sound signal to be transmitted to the client device;
determining an energy ratio between the reference sound signal and the microphone sound signal;
obtaining a preliminary echo cancelling coefficient;
determining a preliminary output signal based on the reference sound signal, the microphone sound signal, and the preliminary echo cancelling coefficient;
iteratively updating the preliminary output signal to generate a first output signal, the iterative updating of the preliminary output signal including:
updating an updating index based on a predetermined step size, the reference sound signal, and an output signal determined in a preceding iteration;
updating the preliminary echo cancelling coefficient based on the updated updating index, the energy ratio, and a predetermined suppression depth; and
updating the preliminary output signal based on the reference sound signal, the microphone sound signal, and the updated preliminary echo cancelling coefficient;
generating a second output signal based on the first output signal and a noise estimate; and
transmitting the second output signal to the client device in replacement of the microphone sound signal.

2. The method of claim 1, further comprising:
determining that the energy ratio between the microphone sound signal and the reference sound signal is less than a ratio threshold and the reference sound signal is greater than an echo threshold; and
increasing a frequency of the iteratively updating of the preliminary output signal.

3. The method of claim 1, further comprising:
determining that the energy ratio between the microphone sound signal and the reference sound signal is less than a ratio threshold and the reference sound signal is greater than an echo threshold;
comparing the output signal determined in the preceding iteration with a threshold;
in response to a comparison result that the output signal determined in the preceding iteration is greater than the threshold, increasing the updating index based on the predetermined step size; and
in response to a comparison result that the output signal determined in the preceding iteration is less than the threshold, decreasing the updating index based on the predetermined step size.

4. The method of claim 1, wherein the generating of the second output signal based on the first output signal and the noise estimate comprises:
determining the noise estimate based on the first output signal and at least one predetermined smoothing factor;
determining a filter coefficient based on the first output signal and the noise estimate;
filtering the first output signal based on the filter coefficient to generate a filtered first output signal;
adjusting the at least one predetermined smoothing factor based on the filtered first output signal;
updating the noise estimate based on the filtered first output signal and the adjusted at least one smoothing factor;
updating the filter coefficient based on the updated noise estimate and the filtered first output signal; and
filtering the filtered first output signal based on the updated filter coefficient to generate the second output signal.

5. The method of claim 1, further comprising:
attenuating frequency bands of second output signal below a cut-off frequency to generate a third output signal.

6. The method of claim 1, further comprising:
adjusting a plurality of frequency bands in the second output signal based on a plurality of parameters across the plurality of frequency bands to generate a third output signal.

7. The method of claim 1, further comprising:
injecting a noise signal to the second output signal to generate a third output signal.

8. The method of claim 7, wherein the noise signal is a pink noise that decreases in amplitude as frequency increases.

9. The method of claim 1, further comprising:
dynamically calculating a gain coefficient for each frame of the second output signal based on a maximum amplitude within the frame; and
apply the gain coefficient on the each frame of the second output signal to generate a third output signal.

10. The method of claim 1, further comprising:
providing a graphical user interface;
receiving user configurations via the graphical user interface; and
adjusting parameters of the embedded system based on the user configurations.

11. The method of claim 1, further comprising:
determining a size of data buffered in the embedded system;
estimating a delay time based on the size of data buffered in the embedded system; and
shifting the reference sound signal by the delay time to align the reference sound signal with the microphone sound signal.

12. An embedded system for signal processing, the embedded system comprising:
a processor; and
a memory storing instructions that, when executed by the processor, configure the embedded system to:
receive a reference sound signal transmitted from a client device;
capture, by a microphone of the embedded system, a microphone sound signal to be transmitted to the client device;
generate a first output signal based on the reference sound signal, the microphone sound signal, and a preliminary echo cancelling coefficient;
determine a noise estimate based on the first output signal and at least one predetermined smoothing factor;
determine a filter coefficient based on the first output signal and the noise estimate;
filter the first output signal based on the filter coefficient to generate a filtered first output signal;
adjust the at least one predetermined smoothing factor based on the filtered first output signal;
update the noise estimate based on the filtered first output signal and the adjusted at least one smoothing factor;
update the filter coefficient based on the updated noise estimate and the filtered first output signal;
filter the filtered first output signal based on the updated filter coefficient to generate a second output signal; and
transmit the second output signal to the client device in replacement of the microphone sound signal.

13. The embedded system of claim 12, wherein to generate the first output signal based on the reference sound signal, the microphone sound signal, and the preliminary echo cancelling coefficient, the instructions configure the embedded system to:
determine an energy ratio between the reference sound signal and the microphone sound signal;
obtain the preliminary echo cancelling coefficient;
determine a preliminary output signal based on the reference sound signal, the microphone sound signal, the preliminary echo cancelling coefficient; and
iteratively update the preliminary output signal to generate the first output signal, the iterative updating of the preliminary output signal including:
update an updating index based on a predetermined step size, the reference sound signal, and an output signal determined in a preceding iteration;
update the preliminary echo cancelling coefficient based on the updated updating index, the energy ratio, and a predetermined suppression depth; and
update the preliminary output signal based on the reference sound signal, the microphone sound signal, and the updated preliminary echo cancelling coefficient.

14. The embedded system of claim 13, wherein the instructions further configure the embedded system to:
determine that the energy ratio between the microphone sound signal and the reference sound signal is less than a ratio threshold and the reference sound signal is greater than an echo threshold; and
increase a frequency of the iteratively updating of the preliminary output signal.

15. The embedded system of claim 13, wherein the instructions further configure the embedded system to:
determine that the energy ratio between the microphone sound signal and the reference sound signal is less than a ratio threshold and the reference sound signal is greater than an echo threshold;
compare the output signal determined in the preceding iteration with a threshold;
in response to a comparison result that the output signal determined in the preceding iteration is greater than the threshold, increase the updating index based on the predetermined step size; and
in response to a comparison result that the output signal determined in the preceding iteration is less than the threshold, decrease the updating index based on the predetermined step size.

16. The embedded system of claim 12, wherein the instructions further configure the embedded system to:
inject a noise signal to the second output signal to generate a third output signal.

17. The embedded system of claim 12, wherein the instructions further configure the embedded system to:
dynamically calculate a gain coefficient for each frame of the second output signal based on a maximum amplitude within the frame; and
apply the gain coefficient on the each frame of the second output signal to generate a third output signal.

18. The embedded system of claim 12, wherein the instructions further configure the embedded system to:
provide a graphical user interface;
receive user configurations via the graphical user interface; and
adjust parameters of the embedded system based on the user configurations.

19. The embedded system of claim 12, wherein the instructions further configure the embedded system to:
determine a size of data buffered in the embedded system;
estimate a delay time based on the size of data buffered in the embedded system; and
shift the reference sound signal by the delay time to align the reference sound signal with the microphone sound signal.

20. A non-transitory computer-readable storage medium, the computer-readable storage medium including instructions for signal processing that when executed by an embedded system, cause the embedded system to:
receive a reference sound signal transmitted from a client device;
capture, by a microphone of the embedded system, a microphone sound signal to be transmitted to the client device;
generate a first output signal based on the reference sound signal, the microphone sound signal, and a preliminary echo cancelling coefficient;
generate a second output signal based on the first output signal and a noise estimate; and
transmit the second output signal to the client device in replacement of the microphone sound signal.
